(19) United States
(12) Patent Application Publication
(10) Pub. No.: US 2004/0089042 A1
(43) Pub. Date: May 13, 2004

(54) Organic potting soil and soil conditioner

(75) Inventor: George H. Henderson, Nampa, ID (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Magic 100 Power Soil, Inc., Nampa, ID (US)

(21) Appl. No.: 10/293,581

(22) Filed: Nov. 12, 2002

(51) Int. Cl. C05F 3/00

(52) U.S. Cl. 71/21

(57) ABSTRACT

A potting soil and topsoil supplementing composition that provides an all-natural combination blended to enhance performance of agricultural, home, and garden soils. The composition uses a specified mixture of compost, sandy loam, Perlite, and diatomaceous earth containing desired quantities of diatomaceous earth, phosphate, magnesium, potassium, and nitrogen. The potting soil amendment also has desired quantities of calcium, magnesium, sulfur, iron, copper, and zinc proportioned in relation to the necessities of the specific soil and combined in proportions to provide good plant nutrition, moisture retention, moisture drainage, and infection and insect resistant properties.

### DESCRIPTION

### BACKGROUND OF THE INVENTION

1. Field of the Invention

The present invention generally relates to soil amendments and potting soil substances, and more particularly to an organic soil amendment product produced from all-natural components designed and blended to improve the quality of soils and foster desired plant growth.

2. Background Information

Since early times, soils have been studied to determine which types of soils are best suited to grow which types of plants. From this analysis, it has been determined that different types of crops and other plants grow best in certain types of soils. In order to prepare a plot of soil to have the desired plant supporting features, soil amendments are formulated and added to soils. A wide variety of materials have been used in various mixtures to attempt to achieve these desired results. Additives have been mixed with soil to assist the soil in performing a variety of functions including retaining water and moisture, elevating soil temperature, controlling weeds, adding nutrients, allowing water to drain from the soil, controlling pests such as insects, bacteria and fungi, and other functions that are required for or conducive to supporting plant growth. The amount of these materials that are to be added to the soil is determined by a combination of the amount of the types of plants to be raised, the desired characteristics of the soil, and the existing characteristics of the soil prior to the addition of any amendments.

One way of amending the soil to improve soil conditions is to use a chemical fertilizer application. Such chemical fertilizer applications are available in a variety of forms. One of the most common forms being a spray wherein the fertilizer is suspended in a liquid and then applied to plants or soils. This method, while effective in some circumstances, also has a variety of shortcomings. First, chemical fertilizers that are applied to plants in such a method usually are placed upon the leaves or stems of the plant, while the part of the plant that needs to obtain the fertilizer is the roots. In order for the fertilizer to reach the roots of the plant, the fertilizer must be washed off of the leaves on to the soil surface. From the soil surface, the fertilizer must percolate the soil to reach the root zone where it can be utilized by the plants. The washing of the fertilizer from the soil may also produce run off that can lead to a variety of environmental issues. In addition, this method of application requires that more fertilizer be applied to the surface than will actually be used by the plants, so as to compensate for fertilizer that is lost through dilution, run off, and other variances.

The addition of commercial fertilizers to a soil while providing the soil with an increased amount of one or several nutrients also depletes the soil of other nutrients and minerals. Over time, the composition of the soil becomes depleted and additional amendments to the soil are required. As a result, plants utilizing the chemical fertilizer deplete the soil of other resources and become stagnated, therefore unable to achieve their full potential. Another negative aspect of chemical fertilizers, and other man-made chemical compositions is that many times these are made of petroleum and other chemical based products that deplete natural resources and place unnatural and non-biodegradable materials into the soil.

In adding materials to a soil, a balance of materials must be struck so as to provide the soil with proper amounts of water retention and to provide desired amounts of aeration within the soil so as to better enable plant growth. For example, soils must have an adequate amount of water retaining material, yet at the same time be sufficiently drainable so as to prevent excesses of water from damaging and hindering plant growth. Soils must also be sufficiently dense to maintain root structure and support the plant, yet at the same time be sufficiently loosely packed so as to allow roots to expand and support plant growth. In addition, soils must contain appropriate quantities of minerals such as calcium, copper, and iron. Soils must also be able to prevent being fully compacted while still retaining moisture in the areas in which roots will grow.

Plants can also be subject to a variety of attacks from pests such as insects, snails, fungi, and bacteria. In addition to providing materials that will assist the plants to grow, often times a pesticide of some sort may be desirable to protect the plant against one or a combination of these and other pests. Commercial pesticides exist in a variety of compositions, however, these chemicals bring with them a host of unwanted side effects including problems with run off, application, toxicity to desired plants, animals, or humans, and a variety of other problems.

Therefore, what is needed is a soil amendment made up of a combination of carefully selected materials that are formulated and combined to provide maximum desired plant growth with limited negative implications. What is also needed is a soil amendment that provides addition of a variety of nutrients to the soil. Another object of the present invention is to provide a soil amendment composition that provides nutrient balance to the soil, as well as providing moisture retaining properties. Another object of the present invention is to provide a soil amendment composition that provides nutrients, water retention, drainage properties, and pest inhibiting properties in one composition and mixture. It is another object of the present invention to provide a soil amendment composition that provides these aforementioned objects, and is made of naturally occurring materials and recycled products.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a potting soil and topsoil supplementing composition that provides an all-natural combination blended to enhance performance of agricultural, home, and garden soils. The soil amendment of the present invention uses high quality compost as its basic component and adds other natural elements, including at least five percent (5%) by volume of a sandy loam, and at least five percent (5%) by volume of a diatomaceous earth component. The diatomaceous earth component containing desired quantities of diatomaceous earth, phosphate, magnesium, potassium, and nitrogen. The potting soil also comprises at least one percent (1%) by volume of Perlite. The potting soil amendment also has desired quantities of calcium, magnesium, sulfur, iron, copper, and zinc proportioned in relation to the necessities of the specific soil and combined in proportions to provide good plant nutrition, moisture retention, moisture drainage, and infection and insect resistant properties.

This combination of soil provides a mixture of organic material, drainage material, water retention, and pest resistant material, as well as the necessary nutrients to allow for optimum soil conditions and for maximum plant growth. This composition, which is made of naturally occurring materials, also uses recycled materials or byproducts from other product processing to obtain and achieve the desired results. For example, in one embodiment of the invention, the sand loam component may be obtained as a byproduct from sugar beet processing. The compost component is from bovines such as from a dairy or feedlot operation. This compost is dried and screened to remove any foreign materials and to ensure that the parts are of a certain desired size.

The exact amounts of the materials follow the above-mentioned general formula, however the exact combination of elements is determined by the necessities of the grower and the characteristics of the soil upon which the soil amendment is to be used.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a potting soil and topsoil conditioning composition made up of at least fifty percent (50%) by volume of organic compost. In the preferred embodiment, this organic compost is derived from animal waste, preferably bovine animal waste, that has been composted, dried, and screened to remove all foreign materials such as wood, stones, etc. The compost is sized to have desired sized pieces, thus creating an optimum particle fraction to enhance the start and to promote the growth of plants and seedlings placed within the soil product. The compost provides organic material for nitrogen fixing bacteria and other beneficial composting agents and microorganisms to produce nutrients for the plants.

Some of the nutrients created by the microorganisms assist other particles such as silt and clay in the existing soil to form together into larger particles. These larger particles provide better drainage of the soil. The addition of organic material to the soil provides for increased amounts of nutrients, increased water drainage, as well as increased water retention.

The potting soil amendment also contains at least five percent (5%) by volume of a sandy loam. Loam is a combination of three basic components sand, silt, and clay. Sandy loam has more sand than typical loam. Sandy loam provides for increased drainage of water from a location because the sand particles are large enough and have sufficient space between them so as to allow the water to drain. In some embodiments of the invention, the sandy loam that is utilized is a byproduct of sugar beet processing. This sandy loam material is rich in naturally occurring nutrients such as calcium, copper, and iron. These elements are sometimes called micronutrients and are needed in smaller quantities than the typical three large nutrients of nitrogen, potassium, and phosphorus. These micronutrients are required to function together with the major nutrients and the plants own processes to provide for proper plant growth.

The potting soil conditioning amendment also comprises at least five percent (5%) by volume of a diatomaceous earth component. Diatomaceous earth provides a variety of functions and features to the soil amendment product and is a key component. First, diatomaceous earth is in and of itself a natural and effective insecticide and pesticide. Thus, the addition of diatomaceous earth provides the plants with natural protection against infectious organisms. This facilitates plant growth and produces high quality products and plants. In addition, diatomaceous earth can hold nearly twenty-seven (27) times its own weight in water. Thus, the diatomaceous earth assists in water retention near the desired root zone portion of the plants. The diatomaceous earth also has aggregate portions that allow excess water to drain away from the plant and assists the user in keeping the soil loose and aerated.

The preferred embodiment of the potting soil and topsoil conditioning composition is made up of at least one percent (1%) by volume of Perlite. Perlite is a naturally occurring siliceous volcanic rock that can be treated with heat to puff up. This puffing gives the stone a larger surface area that allows for both water retention and water drainage. The Perlite also prevents soils from being compacted because of its high crush resistance properties. This helps keep the soil loose and promotes root growth. The Perlite also assists in retaining moisture in the root zone areas and makes the mixture easier to work.

In addition to these materials, various other nutrients may be added to the soil in necessary amounts to provide good plant nutrition, moisture retention, moisture drainage, and infection and insect resistance properties. Some of these additional elements include magnesium, phosphate, nitrogen, potassium, selenium, calcium, sulfur, iron, copper, and zinc. The exact materials and the quantities thereof is determined by a soil scientist.

Nitrogen is needed by plants to create proteins that regulate most of the processes that occur in plants. The addition of nitrogen promotes the vegetative growth of plants. A deficiency of nitrogen causes poor growth, stunted plants, and low yields. An excess of nitrogen causes dark green leaves and growth that may not properly accommodate the root or stem portions of the plants. Because nitrogen is a component of chlorophyll, a yellow color, beginning with the lower leaves, is a common symptom of nitrogen deficiency.

Phosphate is needed by plants to perform energy transfer as well as being an important structural component of the phospholipid cell membrane. Phosphate is considered an essential element for plant growth. Phosphorus is said to promote root growth, root branching, stem growth, flowering, fruiting, seed formation, and maturation. When phosphorus is lacking, stems and foliage may have a red or purplish tinge.

Potassium is needed by plants to act as a catalyst for a variety of metabolic functions. Potassium enables the plant to more readily withstand “stress” such as drought, cold, heat, and disease. It also stimulates flower color and promotes tuber formation and a strong root system. When potassium is lacking, leaves appear dry and scorched on the edges and have irregular yellowing coloration.

Magnesium is needed by plants as an enzyme activator and as a component of part of chlorophyll. Magnesium is needed for proper fruit yields. Deficiencies of magnesium will produce stunted growth and poor fruit yields. Magnesium is also needed in conjunction with the calcium and potassium to regulate the transport functions through the cell membranes. Since calcium, magnesium, and potassium work together, the respective amounts of each of these must be balanced.

Selenium is a trace nutrient required by human beings in small amounts for good health. While selenium can be obtained by a variety of supplements, absorption of selenium into food plants from soil assists in providing humans with this required nutrient. The amount of selenium to be included in a mixture is dependant upon the preexisting levels of selenium in the soil. In some areas of the country, selenium levels are already too high and are considered contaminants. In these situations, addition of selenium would be inappropriate.

Calcium is needed by plants as a cell wall component and enzyme activator. Deficiencies in calcium result in poor plant growth and fruit quality. Excesses of calcium can create deficiencies in magnesium. Calcium deficiencies are also noted by damage to new growth tips.

Sulfur is a component of a plant's amino acids. Plants that do not have enough sulfur are stunted, thin-stemmed, and spindly. The younger leaves are light green or yellow. Fruit and seed maturity may be delayed when sulfur is lacking. Various forms of sulfur may be added to basic (alkali) soils to acidify them (or lower the pH).

Copper is a component of plant enzymes. The presence of copper in appropriate amounts contributes to plant health.

Zinc is an enzyme activator. Plants that lack zinc are typically yellow in color and fail to thrive. When levels of zinc are too high, iron deficiency can result. Iron is an element of chlorophyll and is necessary for green healthy plants.

The exact form in which these materials can be added to the soil mixture can vary depending upon the exact necessities of the user. In some applications, both commercial and natural fertilizers may be mixed with the components of the soil conditioner and planting soil to bring about a desired composition for application. In other applications, the desired soil attributes may be obtained by mixing a variety of materials into the soil including bone meal, alfalfa, corn gluten, potash, manure from a variety of animals including horse, cows, pigs, chickens, bats, sheep, and various microbes that have the ability to separate, produce, and fix various desired elements and characteristics into a soil.

Two preferred embodiments of soil supplements are known and are set forth hereafter. While specific amounts of various parts are set forth, it is to be distinctly understood that variations from these general formulas are also contemplated within the scope of the invention. Therefore the amounts of materials stated hereafter should be interpreted as illustrative in nature and not as limiting.

One embodiment is best used as a potting soil and topsoil conditioning composition. This composition is seventy to eighty percent (70-80%) by volume an organic compost with between ten to twenty percent (10-20%) by volume of sandy loam, five to ten percent (5-10%) by volume of diatomaceous earth, which contains a desired level of selenium, magnesium, phosphate, nitrogen, potassium, and between one and two percent (12%) by volume of Perlite. Preferably the mixture is one where the percentage by volume are as follows: seventy-five percent (75%) compost, fifteen percent (15%) sandy loam, eight percent (8%) diatomaceous earth made up of selenium, magnesium, potassium, phosphate, and nitrogen, and two percent (2%) Perlite. Depending on the exact needs of the ground upon which the soil product is to be placed, the exact amounts of these elements may be varied. Additional portions of calcium, magnesium, sulfur, iron, copper, and zinc may be added to the soil to assist in good plant development and growth. The exact formulations will change based upon the analysis of the basis compost utilized and a local soil analysis.

Another composition is also thought of wherein the mixture is made up of the following components listed in percentages by volume: compost seventy percent (70%), sandy loam ten percent (10%), diatomaceous earth made up of phosphate, magnesium, nitrogen, and potassium eighteen percent (18%), and Perlite two percent (2%). This mixture is intended for use in conditioning large quantities of soil. However, other uses may also be found to be appropriate depending upon the necessities of the user and the local soil conditions.

This application provides a variety of advantages, including that the potting soil amendment is made of all-natural soil conditioners, therefore problems stemming form pollution from with drainage of commercial fertilizers into other areas such as water supplies does not exist. This device also provides an advantage over the prior art in that soils used in production of food products and home gardening industry are deficient of an important element needed to produce healthy plants. This invention has the ability to make most soils productive and additionally provides an all-natural method of pesticide and insecticide resistance.

In a preferred embodiment, these elements are mixed according to protocol established by a soil scientist after testing the basic compost and the soil upon which the amendment is to be placed. He/she then prepares a formulation to be blended utilizing the listed elements to produce the desired end product. Each element used in the product has a proven track record of producing healthy and strong plant growth.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A potting soil and topsoil conditioning composition comprised of:
at least about 50 percent by volume of an organic compost;
at least about 5 percent by volume of a sandy loam;
at least about 5 percent by volume of a diatomaceous earth component, said component containing diatomaceous earth, Phosphate, Magnesium, Potassium and Nitrogen; and
at least about 1 percent by volume of Perlite in proportions to provide good plant nutrition, moisture retention, moisture drainage and infection and insect resistance properties.

2. The potting soil and topsoil conditioning composition of claim 1 further comprising a desired quantity of selenium.

3. The potting soil and topsoil conditioning composition of claim 1 wherein said composition further comprises a desired amount of sulfur.

4. The potting soil and topsoil conditioning composition of claim 1 wherein said organic compost is dried, screened, organic compost free of foreign materials.

5. The potting soil and topsoil conditioning composition of claim 1 wherein said composition further comprises a desired level of iron.

6. The potting soil and top soil conditioning composition of claim 1 wherein said composition comprises between 70 and 80 percent by volume of an organic compost, between 10 and 20 percent by volume of a sandy loam, between 8 and 10 percent by volume of a diatomaceous earth component, said diatomaceous earth containing a desired level of selenium, magnesium, potassium, phosphate, and nitrogen; and between 1 and 3 percent by volume of Perlite.

7. The potting soil and topsoil conditioning composition of claim 1 wherein said organic compost is obtained from animal waste, that is composted, dried, screened and sized.

8. The potting soil and topsoil conditioning composition of claim 1 wherein said sandy loam is a byproduct of sugar beet processing.

9. A top soil supplementing composition comprised of:
between 60 and 80 percent by volume of an organic compost;
between 5 and 15 percent by volume of a sandy loam;
between 15 and 25 percent by volume of a diatomaceous earth component, said diatomaceous earth component comprised of diatomaceous earth together with amounts of phosphate, magnesium, nitrogen and potassium;
and between 1 and 3 percent by volume of Perlite in proportions to provide good plant nutrition, moisture retention, moisture drainage, and insect and infection resistance for a desired crop in a desired location.

10. The topsoil supplementing composition of claim 9 further comprising a desired amount of calcium.

11. The topsoil supplementing composition of claim 10 further comprising a desired amount of magnesium.

12. The topsoil supplementing composition of claim 10 further comprising a desired amount of sulfur.

13. The topsoil supplementing composition of claim 10 further comprising a desired amount of iron.

14. The topsoil supplementing composition of claim 10 further comprising a desired amount of copper.

15. The topsoil supplementing composition of claim 10 further comprising a desired amount of zinc.

16. A potting soil and topsoil supplementing composition comprised of:
at least about 50 percent by volume of an organic compost; said organic compost having been derived from animal waste, composted, dried and screened to obtain a desired size;
at least about 5 percent by volume of a sandy loam, said sandy loam obtained as a by product of sugar beet processing;
at least about 5 percent by volume of a diatomaceous earth component, said diatomaceous earth component containing desired quantities of diatomaceous earth, Phosphate, Magnesium, Potassium, and Nitrogen;
at least about 1 percent by volume of Perlite; and
desired quantities of calcium, magnesium, sulfur, iron, copper, and zinc in proportions to provide good plant nutrition, moisture retention, moisture drainage and infection and insect resistance properties.
